(19) United States
(12) Patent Application Publication
(10) Pub. No.: US 2026/0318336 A1
(43) Pub. Date: Oct. 15, 2026

(54) Adjusting Device

(71) Applicant: Illinois Tool Works Inc., Glenview, IL (US)

(72) Inventors: Leyao Zhang, Shanghai (CN); Jiahui He, Shanghai (CN); Zhilin Li, Shanghai (CN)

(21) Appl. No.: 19/642,323

(22) Filed: Apr. 8, 2026

(30) Foreign Application Priority Data
Apr. 11, 2025 (CN) 2025104576367
Apr. 2, 2026 (CN) 202620437980X
Apr. 2, 2026 (CN) 2026104329006

(51) Int. Cl. F16B 5/02

(52) U.S. Cl. CPC F16B 5/0233; F16B 5/0283

(57) ABSTRACT

An adjusting device including an adjusting element and a sleeve. The adjusting element is axially through and includes a first axial end and an engaging portion protruding radially inward. The adjusting element is threadedly connected to a first component. The sleeve is at least partly within the engaging portion of the adjusting element and configured to receive a fastening device to be fastened to a second component. The engaging portion is provided with a first direction limiting structure and a second direction limiting structure. The first direction limiting structure cooperates with the sleeve to limit an axial movement of the sleeve relative to the adjusting element in a first direction, and the second direction limiting structure cooperates with the sleeve to limit an axial movement of the sleeve relative to the adjusting element in a second direction opposite to the first direction. The present disclosure not only prevents the generation of undesired rotation of the adjusting element relative to the sleeve under vibration conditions, but also eliminates the need for an operator to overcome great rotational resistance when it is desired to rotate the adjusting element relative to the sleeve to adjust an axial position of the first component relative to the second component.

### RELATED APPLICATIONS

The present application claims the benefit of Chinese Patent Application No. 2025104576367, filed Apr. 11, 2025, Chinese Patent Application No. 2026104329006X, filed Apr. 2, 2026, and Chinese Patent Application No. 202620437980X, filed Apr. 2, 2026, each titled “Adjusting Device,” the contents of which are hereby incorporated by reference.

### BACKGROUND

The present disclosure relates to an adjusting device, and in particular to an adjusting device for providing tolerance compensation in both lateral and axial directions. In the prior art, an adjusting device is used in cooperation with a fastening device to connect a first component to a second component. For example, in automobile manufacturing, the adjusting device is used to fasten a vehicle lamp to a vehicle body. A trim panel carrying the vehicle lamp is installed on the adjusting device, and the adjusting device is fastened to the vehicle body by the fastening device, thereby securing the vehicle lamp to the vehicle body. The adjusting device compensates for tolerances in the lateral and axial directions between the components to be installed, such as the vehicle lamp and the vehicle body. The adjusting device includes an adjusting member and a sleeve, with the adjusting member arranged around the sleeve. The sleeve is retained within the adjusting member to facilitate installation of the adjusting device. The first component is installed to the outside of the adjusting member. The sleeve is provided with a support plate. The fastening device passes through the support plate to fasten the sleeve to the second component. Lateral tolerance compensation is achieved by moving the support plate laterally so that the fastening device can align with the second component for fastening. The sleeve protrudes axially beyond the adjusting member so that the adjusting member is not clamped when the fastening device is fastened to the second component. There is a clearance between the adjusting member and the support plate on the sleeve. After the sleeve is fastened to the second component, a tool can be used to drive the adjusting member to rotate, thereby adjusting the axial position of the first component relative to the second component, thus achieving axial tolerance compensation.

The adjusting member and the sleeve of the adjusting device tightly fit each other in the radial direction to generate an axial resistance therebetween to prevent the sleeve from moving (e.g., axially) relative to the adjusting member, which causes detachment of the sleeve therefrom, before the adjusting device is installed, and to generate a rotational resistance to prevent the adjusting member from rotating relative to the sleeve due to vibration after the adjusting device is installed in place (e.g., after the sleeve is fastened to the second component). The adjusting device is not pre-assembled with a support plate. The adjusting member and the sleeve are integrally injection-molded, with a weak connection structure provided at their joint base.

### SUMMARY

The present disclosure relates generally to an adjusting device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 is a cross-sectional view of an adjusting device connecting a first component to a second component in cooperation with a fastening device according to a first embodiment of the present disclosure.

FIG. 2A is a first cross-sectional view of the adjusting device shown in FIG. 1.

FIG. 2B is a second cross-sectional view of the adjusting device shown in FIG. 2A.

FIG. 2C is an exploded view of the adjusting device shown in FIG. 2A.

FIG. 3A is a cross-sectional view of an adjusting device according to a second embodiment of the present disclosure.

FIG. 3B is a perspective view of a sleeve of the adjusting device shown in FIG. 3A.

FIG. 3C is a perspective view of an adjusting element of the adjusting device shown in FIG. 3A.

FIG. 4A is a cross-sectional view of an adjusting device according to a third embodiment of the present disclosure.

FIG. 4B is a perspective view of a sleeve of the adjusting device shown in FIG. 4A.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain examples” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

It has been discovered through long-term observation and research that the adjusting member and the sleeve are radially fitted to simultaneously generate both an axial resistance and a rotational resistance therebetween, thus causing the rotational resistance to be affected by the axial resistance. In situations where the radial fit between the adjusting member and the sleeve needs to generate a relatively large axial resistance to limit an axial movement of the sleeve relative to the adjusting member before the adjusting device is installed, a relatively large rotational resistance may also be generated by the radial fit, so that it can prevent undesired rotation of the adjusting member relative to the sleeve due to vibration after the adjusting device is installed in place. However, when it is desired to rotate the adjusting element relative to the sleeve to adjust an axial position of the first component relative to the second component after the adjusting device is installed in place, an operator needs to overcome a relatively large rotational resistance. When the sleeve protrudes axially beyond the adjusting member to generate a clearance between the adjusting member and the support plate on the sleeve, it would cause abnormal noise in parts, such as, due to vibration of the vehicle body (the second component). The absence of a pre-assembled support plate in the adjusting device would require a compatible support plate to be additionally bought/manufactured and installed subsequently, thereby causing increased assembly costs. Furthermore, the weak connection structure generated by the integral injection molding of the adjusting member and the sleeve would result in a reduced space for the radial movement of the support plate and the fastening device, thereby causing a reduced tolerance compensation amount of the adjusting device in the radial (lateral) direction.

In order to solve the above problems, according to a first aspect of the present disclosure, the present disclosure provides an adjusting device for connecting a first component to a second component in cooperation with a fastening device. The adjusting device includes an adjusting element and a sleeve. The adjusting element is axially through and includes a first axial end and an engaging portion protruding radially inward. The engaging portion is annular and provided close to the first axial end. The adjusting element is configured to be threadedly connected to the first component. The sleeve is at least partly within the engaging portion of the adjusting element and configured to receive the fastening device to be fastened to the second component. The engaging portion of the adjusting element is provided with a first direction limiting structure and a second direction limiting structure. The first direction limiting structure cooperates with the sleeve to limit an axial movement of the sleeve relative to the adjusting element in a first direction, and the second direction limiting structure cooperates with the sleeve to limit an axial movement of the sleeve relative to the adjusting element in a second direction opposite to the first direction.

In some aspects, the engaging portion is in clearance fit with the sleeve in a radial direction.

In some aspects, the first direction limiting structure includes a step portion provided on an inner side wall of the engaging portion. The second direction limiting structure includes a stop structure provided on the engaging portion close to the first axial end of the adjusting element. The sleeve is provided with a first protruding structure protruding radially outward on a side wall thereof, and the sleeve is provided with a second protruding structure close to a first end thereof. The first end is close to the first axial end of the adjusting element. The step portion cooperates with the first protruding structure to limit the axial movement of the sleeve relative to the adjusting element in the first direction. The stop structure cooperates with the second protruding structure to limit the axial movement of the sleeve relative to the adjusting element in the second direction.

In some aspects, the stop structure includes a first end face of the engaging portion. The second protruding structure includes a flange extending radially outward from the first end of the sleeve. The first end face of the engaging portion abuts against the flange.

In some aspects, the stop structure includes a recess provided on the inner side wall of the engaging portion. The second protruding structure includes an annular protrusion protruding radially outward from the side wall of the sleeve. The recess cooperates with the annular protrusion to limit the axial movement of the sleeve relative to the adjusting element in the second direction.

In some aspects, the step portion is annular. The first protruding structure includes a plurality of projections circumferentially spaced apart.

In some aspects, the inner side wall of the engaging portion above the step portion is in clearance fit with the first protruding structure. A surface of the step portion facing the side wall of the sleeve is in clearance fit with the side wall of the sleeve below the first protruding structure.

In some aspects, the adjusting device further includes a support plate and a retaining element. The support plate is received within the adjusting element and configured to receive the fastening device to enable the sleeve to be fastened to the second component. The retaining element is detachably connected to the adjusting element to retain the support plate between the engaging portion and the retaining element.

In some aspects, the retaining element includes an elastic annular member with a polygonal shape.

In some aspects, the engaging portion is provided with at least one protruding portion on a second end face thereof. The second end face is close to the support plate. The at least one protruding portion is contactable with the support plate.

In some aspects, the adjusting device further includes an outer drive structure and/or an inner drive structure. The outer drive structure is provided on an outer side of the adjusting element and close to a second axial end of the adjusting element opposite to the first axial end. The inner drive structure is provided on an inner side of the adjusting element and close to the second axial end of the adjusting element. The outer drive structure and/or the inner drive structure are configured to be driven to rotate so as to rotate the adjusting element.

According to a second aspect of the present disclosure, the present disclosure provides an adjusting device for connecting a first component to a second component in cooperation with a fastening device. The adjusting device includes an adjusting element, a sleeve, a support plate and a retaining element. The adjusting element is axially through and has an engaging portion protruding radially inward. The engaging portion is annular. The adjusting element is configured to be threadedly connected to the first component. The sleeve is at least partly within the engaging portion of the adjusting element and configured to receive the fastening device to be fastened to the second component. The support plate is within the adjusting element and configured to receive the fastening device to enable the sleeve to be fastened to the second component. The retaining element is detachably connected to the adjusting element. The adjusting element is provided with a limiting portion. The limiting portion cooperates with the sleeve to limit the sleeve from moving out of the adjusting element in a direction away from the retaining element. The retaining element retains the support plate between the sleeve and the retaining element, and limits the sleeve from moving out of the adjusting element in a direction towards the retaining element by the support plate.

In some aspects, the engaging portion is in clearance fit with the sleeve in a radial direction.

In some aspects, the limiting portion includes a step portion provided on an inner side wall of the engaging portion. The sleeve is provided with at least one projection protruding radially outward from a side wall thereof. The step portion cooperates with the at least one projection to limit the sleeve from moving out of the adjusting element in the direction away from the retaining element.

In some aspects, the step portion is annular. The sleeve is provided with a plurality of projections circumferentially spaced apart.

In some aspects, the retaining element includes an elastic annular member with a polygonal shape.

In some aspects, the engaging portion is provided with at least one protruding portion on an end face thereof. The end face is close to the support plate. The at least one protruding portion is contactable with the support plate.

In some aspects, the adjusting device further includes an outer drive structure and/or an inner drive structure. The outer drive structure is provided on an outer side of the adjusting element and close to an axial end of the adjusting element away from the engaging portion. The inner drive structure is provided on an inner side of the adjusting element and close to the axial end of the adjusting element. The outer drive structure and/or the inner drive structure are configured to be driven to rotate so as to rotate the adjusting element.

The adjusting device provided in the present disclosure uses structures independent of each other to limit a relative rotation and a relative axial movement between the adjusting element and the sleeve so that the rotational resistance experienced by the adjusting element is not related to the axial resistance experienced by the sleeve. As a result, in situations where the sleeve is limited from moving out of the adjusting element in an axial direction, the rotational resistance experienced by the adjusting element can be controlled within a certain range, thereby not only preventing the generation of undesired rotation of the adjusting element relative to the sleeve under vibration conditions, but also eliminating the need for an operator to overcome great rotational resistance when it is desired to rotate the adjusting element relative to the sleeve to adjust an axial position of the first component relative to the second component.

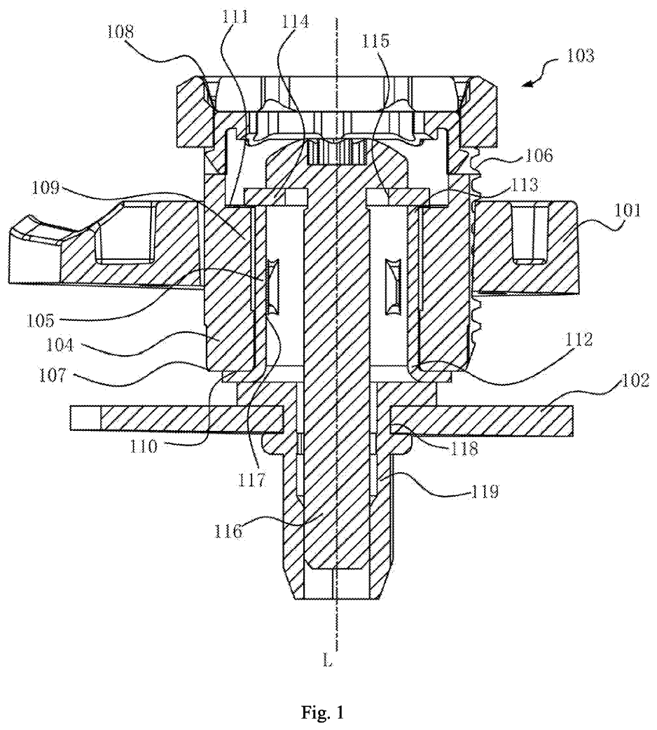

FIG. 1 is a cross-sectional view of an adjusting device 103 connecting a first component 101 to a second component 102 in cooperation with a fastening device 116 according to a first embodiment of the present disclosure.

As shown in FIG. 1, the adjusting device 103 includes an adjusting element 104 and a sleeve 105. The adjusting element 104 is axially through. The sleeve 105 is at least partly within the adjusting element 104. The sleeve 105 is configured to receive the fastening device 116 to be fastened to the second component 102. The adjusting element 104 is threadedly connected to the first component 101. The adjusting element 104 is cylindrical and provided with an outer thread 106 on its outer side wall. The outer thread 106 is configured to be connected to the first component 101 so as to connect the adjusting element 104 to the first component 101. The adjusting element 104 is connected to the first component 101 in such a way that when the adjusting element 104 rotates around its longitudinal axis L (no axial movement), the first component 101 moves relative to the adjusting element 104 in the axial direction. Thus, when the sleeve 105 is secured to the second component 102, an axial distance of the first component 101 relative to the adjusting element 104 can be adjusted by the rotation of the adjusting element 104 around its longitudinal axis L relative to the sleeve 105 so that the adjusting device 103 can adjust the tolerance between the first component 101 and the second component 102 in the axial direction. For example, the first component 101 is a vehicle lamp, and the second component 102 is a vehicle body.

The adjusting element 104 includes a first axial end 107 and a second axial end 108 opposite to each other. The adjusting element 104 further includes an engaging portion 109 protruding radially inward. The engaging portion 109 is annular and provided close to the first axial end 107. The engaging portion 109 includes a first end face 110 and a second end face 111 opposite to each other. The sleeve 105 is at least partly within the engaging portion 109. The sleeve 105 includes a first end 112 and a second end 113 opposite to each other, which are close to the first axial end 107 and the second axial end 108 of the adjusting element 104, respectively.

The adjusting device 103 further includes a support plate 114 received within the adjusting element 104. The support plate 114 is configured to receive the fastening device 116 to enable the sleeve 105 to be fastened to the second component 102. The support plate 114 has a central opening 115. The fastening device 116 passes through the central opening 115 of the support plate 114 and a through opening 117 of the sleeve 105 to fasten the sleeve 105 to the second component 102. A fastening structure 119 is installed in an opening 118 of the second component 102. The fastening device 116 is secured to the fastening structure 119 to fasten the sleeve 105 to the second component 102. The second end 113 of the sleeve 105 protrudes axially beyond the second end face 111 of the engaging portion 109 so that when fastening the sleeve 105, the fastening device 116 would not clamp the adjusting element 104 simultaneously, thereby not affecting the required subsequent rotation of the adjusting element 104. The support plate 114 is arranged on the second end 113 of the sleeve 105 and above the second end face 111 of the engaging portion 109. The support plate 114 is laterally (radially) movable within the adjusting element 104 to enable the fastening device 116 to align with the fastening structure 119 of the second component 102. The fastening device 116 is then secured to the fastening structure 119. In this way, the adjusting device 103 can adjust the tolerance between the first component 101 and the second component 102 in the lateral direction. During installation, the adjusting element 104 is connected to the first component 101, such as, installed to the first component 101 by the outer thread 106, then the sleeve 105 of the adjusting device 103 is fastened to the second component 102 by the fastening device 116, so that the first component 101 is connected to the second component 102.

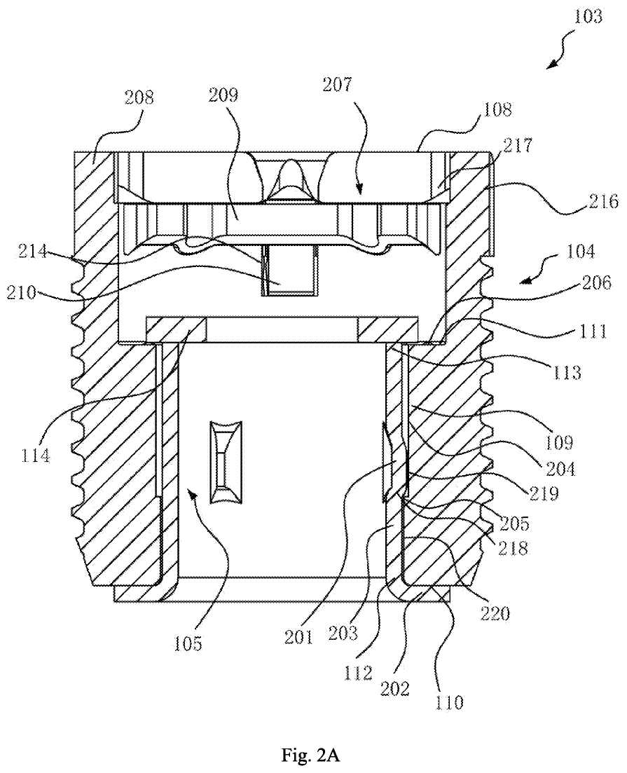

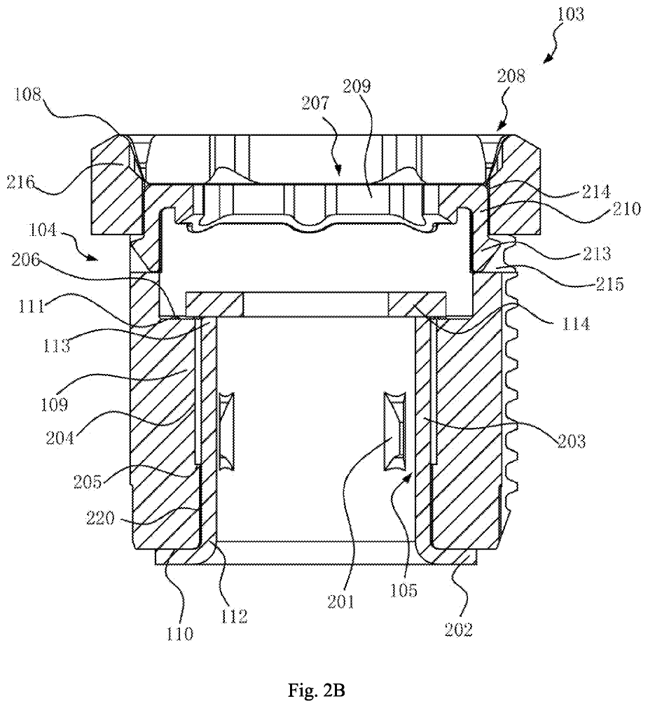

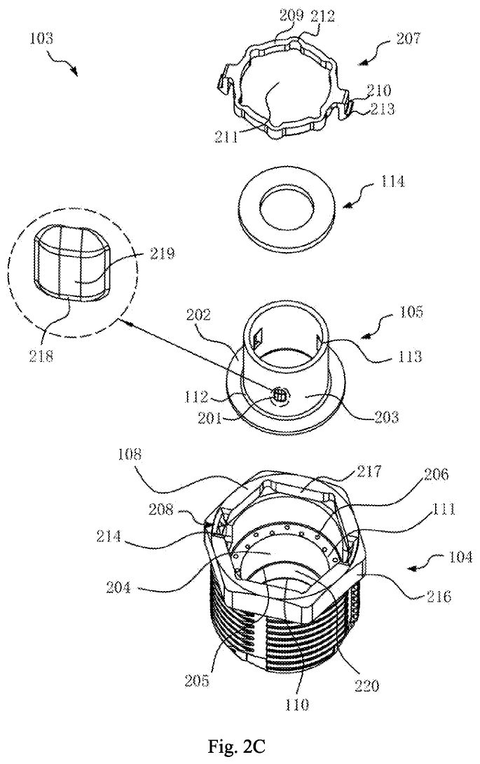

FIG. 2A is a first cross-sectional view of the adjusting device 103 shown in FIG. 1, FIG. 2B is a second cross-sectional view of the adjusting device 103 shown in FIG. 2A, and FIG. 2C is an exploded view of the adjusting device 103 shown in FIG. 2A. The first and second cross-sectional views are those obtained by cutting along different section lines.

The sleeve 105 of the adjusting device 103 needs to be retained within the adjusting element 104 without moving out of the adjusting element 104 so as to facilitate to install the adjusting device 103, as a whole, to the first component and the second component. After the adjusting device 103 is installed to the first component and the second component, it needs to limit the rotation of the adjusting element 104 relative to the sleeve 105 fastened to the second component 102 so as to overcome the rotation of the adjusting element 104 caused by the vibration of the adjusting device 103. However, when the adjusting element 104 needs to rotate to adjust an axial position of the first component relative to the second component (i.e., compensating for an axial tolerance), it is desired to apply a relatively small force to drive the adjusting element 104 to rotate relative to the sleeve 105.

In order to achieve the above object, as shown in FIGS. 2A-2C, in the present disclosure, the engaging portion 109 of the adjusting element 104 is provided with a first direction limiting structure and a second direction limiting structure. The first direction limiting structure cooperates with the sleeve 105 to limit an axial movement of the sleeve 105 relative to the adjusting element 104 in a first direction, and the second direction limiting structure cooperates with the sleeve 105 to limit an axial movement of the sleeve 105 relative to the adjusting element 104 in a second direction opposite to the first direction so as to prevent the sleeve 105 from moving in the axial direction and detaching from the adjusting element 104. In addition, the engaging portion 109 is in clearance fit with the sleeve 105 in a radial direction. The rotational resistance between the adjusting element 104 and the sleeve 105 generated by the clearance fit is not related to the axial resistance generated by the cooperation of the first direction limiting structure and the second direction limiting structure with the sleeve 105 for preventing the sleeve 105 from detaching from the adjusting element 104. In the present disclosure, a range of clearance between the engaging portion 109 and the sleeve 105 in a radial direction can be adjusted to generate a predetermined rotational resistance between the adjusting element 104 and the sleeve 105.

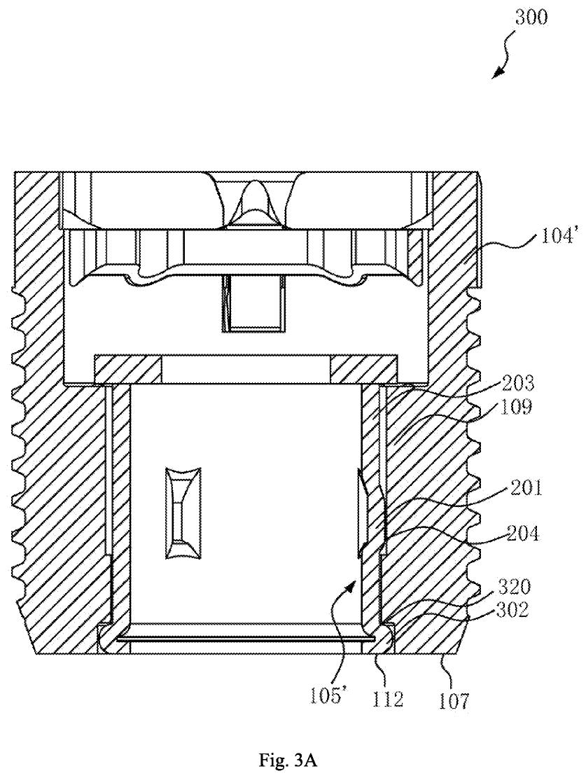

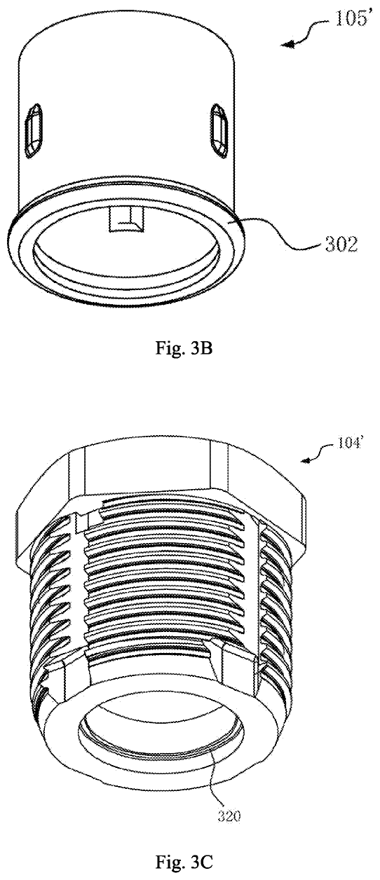

In an embodiment, the first direction limiting structure includes a step portion 205 provided on an inner side wall 204 of the engaging portion 109. The second direction limiting structure includes a stop structure provided on the engaging portion 109 close to the first axial end 107 of the adjusting element 104. The sleeve 105 is provided with a first protruding structure 201 protruding radially outward on a side wall 203 thereof. The sleeve 105 is provided with a second protruding structure 202 close to the first end 112 thereof. The first direction limiting structure cooperates with the first protruding structure 201 to limit the axial movement of the sleeve 105 relative to the adjusting element 104 in the first direction (axially downward as shown in FIGS. 2A-2B). The second direction limiting structure cooperates with the second protruding structure 202 to limit the axial movement of the sleeve 105 relative to the adjusting element 104 in the second direction (axially upward as shown in FIGS. 2A-2B). The step portion 205 is annular. The stop structure includes the first end face 110 of the engaging portion 109. The second protruding structure 202 includes a flange extending radially outward from the first end 112 of the sleeve 105. The first end face 110 of the engaging portion 109 abuts against the flange to limit the axial movement of the sleeve 105 relative to the adjusting element 104 in the second direction (axially upward as shown in FIGS. 2A-2B). The flange is annular. The first protruding structure 201 includes a plurality of projections circumferentially spaced apart. The first protruding structure 201 further includes at least one projections. In other embodiments, the stop structure and the second protruding structure include other suitable structures, such as, that shown in FIGS. 3A-3C.

The side wall 203 of the sleeve 105 is in clearance fit with the inner side wall 204 of the engaging portion 109 to generate a predetermined rotational resistance between the adjusting element 104 and the sleeve 105. The inner side wall 204 of the engaging portion 109 above the step portion 205, as the first direction limiting structure, is in clearance fit with the first protruding structure 201. As shown in FIG. 2C and its partial enlarged view, the first protruding structure 201 includes an engaging end portion 218 and an outside portion 219. The engaging end portion 218 is provided close to the first end 112 of the sleeve 105. The outside portion 219 faces the outside of the first protruding structure 201. The engaging end portion 218 abuts against the step portion 205 of the engaging portion 109 to limit the axial movement of the sleeve 105 relative to the adjusting element 104 in the first direction (axially downward). The outside portion 219 is in clearance fit with the inner side wall 204 of the engaging portion 109 above the step portion 205. A surface 220 of the step portion 205 facing the side wall 203 of the sleeve 105 is in clearance fit with the side wall 203 of the sleeve 105 below the first protruding structure 201. In an embodiment, the first direction limiting structure and the second direction limiting structure are configured to have a clearance with the sleeve 105 in the axial direction so that the sleeve 105 would not press the adjusting element 104 in the axial direction, thereby avoid increasing a rotational resistance experienced by the adjusting element 104.

When the adjusting device 103 is installed to the second component 102 (see FIG. 1) by the fastening device 116, the second end 113 of the sleeve 105 protrudes axially beyond the second end face 111 of the engaging portion 109 so that there is a clearance between a bottom surface of the support plate 114 and the second end face 111 of the engaging portion 109 to prevent the adjusting element 104 from being clamped so that it cannot rotate, thereby not achieving the tolerance compensation of the adjusting device 103 in the axial direction. However, the clearance would cause the support plate 114 to shake when the second component (such as, the vehicle body) vibrates, thus causing abnormal noise in parts. In order to solve the above problem, in the present disclosure, the engaging portion 109 is provided with at least one protruding portion 206 on its second end face 111, which is close to the support plate 114. The at least one protruding portion 206 is contactable with the support plate 114. The protruding portion 206 can eliminate the clearance between the bottom surface of the support plate 114 and the second end face 111 of the engaging portion 109, thus reducing or eliminating abnormal noise in parts caused by vibration. In an embodiment, the protruding portion 206 includes a plurality of bumps circumferentially spaced apart. As shown in FIG. 2C, the bumps are arranged in two rows in a staggered manner. The bumps are configured such that there is a relatively small contact area between the support plate 114 and the second end face 111 of the engaging portion 109 to reduce the fastening force of the support plate 114 on the engaging portion 109 of the adjusting element 104 when the fastening device 116 (see FIG. 1) fastens the support plate 114 and the sleeve 105, thereby reducing the force required for subsequent rotation of the adjusting element 104. In other embodiments, the protruding portion 206 includes other suitable structures to achieve the above functions. The protruding portion 206 can be configured in amount, height, shape, etc., to generate a predetermined rotational resistance between the adjusting element 104 and the sleeve 105. The clearance fit between the sleeve 105 and the engaging portion 109 in the radial direction cooperates with the protruding portion 206 on the second end face 111 of the engaging portion 109 to generate a certain range of force between the adjusting element 104 and the sleeve 105, thereby not only preventing the generation of undesired rotation of the adjusting element 104 relative to the sleeve 105 under vibration conditions, but also eliminating the need for an operator to overcome great rotational resistance when it is desired to rotate the adjusting element 104 relative to the sleeve 105 to adjust the axial position of the first component relative to the second component.

The adjusting device 103 further includes a retaining element 207. The retaining element 207 is detachably connected to the adjusting element 104 to retain the support plate 114 between the engaging portion 109 and the retaining element 207. The retaining element 207 is arranged on an inner side of the adjusting element 104 and close to the second axial end 108 of the adjusting element 104. The adjusting element 104 includes an installing component 208 provided on the second axial end 108. The installing component 208 and the retaining element 207 are in form fit to detachably secure the retaining element 207 to the adjusting element 104. As shown in FIG. 2C, the retaining element 207 includes a main body 209 and a leg portion 210. The main body 209 has a central opening 211. The main body 209 includes an elastic annular member with a polygonal shape to deform the main body 209 to be installed in the installing component 208. For example, the polygonal shape is hexagon. The main body 209 has a weakened structure 212 at the corners of the elastic annular member to facilitate the deformation of the main body 209 to insert the retaining element 207 into the installing component 208. In an embodiment, the retaining element 207 is made of plastic. The central opening 211 is sized to allow the fastening device to pass through the central opening 211 and to prevent the support plate 114 from passing through the central opening 211, which causes detachment of the support plate 114 from the adjusting element 104. The leg portion 210 extends from the main body 209 in the axial direction. The leg portion 210 is provided with a snap-fit portion 213 on its end portion away from the main body 209 for snap-fitting to the installing component 208. In an embodiment, the retaining element 207 includes two leg portions 210 opposite to each other.

The installing component 208 includes a recess 214 and an opening 215. The recess 214 is recessed radially outward from the inner side wall of the adjusting element 104 close to the second axial end 108. The opening 215 is adjacent to the recess 214 and away from the second axial end 108 of the adjusting element 104. The opening 215 is configured to extend radially through the side wall of the adjusting element 104. The leg portion 210 can be retained in the recess 214 to prevent circumferential movement. The snap-fit portion 213 snaps into the opening 215 to prevent axial movement. In other embodiments, the present disclosure includes other suitable structures of the retaining element and the installing component to achieve the above functions.

The adjusting element 104 further includes an outer drive structure 216 and/or an inner drive structure 217. The outer drive structure 216 can be driven, e.g., by a tool, to rotate so as to rotate the adjusting element 104, thereby adjusting the axial position of the first component relative to the second component. The inner drive structure 217 can be driven, e.g., by a tool, to rotate so as to rotate the adjusting element 104, thereby adjusting the axial position of the first component relative to the second component. For example, the outer drive structure 216 and the inner drive structure 217 have a generally hexagonal outline. The outer drive structure 216 is provided on an outer side of the adjusting element 104 and close to the second axial end 108 of the adjusting element 104. The inner drive structure 217 is provided on an inner side of the adjusting element 104 and close to the second axial end 108 of the adjusting element 104. Both the outer drive structure 216 and the inner drive structure 217 are provided to enable the adjusting device 103 to adapt to tools with different sizes, thereby improving the operability of the adjusting device 103. In other embodiments, the outer drive structure and the inner drive structure include other suitable structures and arrangements to achieve the above functions.

The adjusting element 104 and the sleeve 105 are manufactured separately to overcome the problem in the prior art that a weak connection structure generated by an integral injection molding occupies space in the radial direction so that the tolerance compensation amount of the adjusting device in the radial (lateral) direction is reduced. In an embodiment, the adjusting element 104 is made of plastic. The sleeve 105 is made of metal for increasing durability.

FIG. 3A is a cross-sectional view of an adjusting device 300 according to a second embodiment of the present disclosure, FIG. 3B is a perspective view of a sleeve 105′ of the adjusting device 300 shown in FIG. 3A, and FIG. 3C is a perspective view of an adjusting element 104′ of the adjusting device 300 shown in FIG. 3A.

The adjusting device 300 in FIG. 3A has substantially the same structure as the adjusting device 103 in FIGS. 2A-2C. The difference is that a second direction limiting structure and a second protruding structure of the adjusting device 300 in FIG. 3A have different structures from those of the adjusting device 103 in FIGS. 2A-2C, while the both achieve the same function. As shown in FIG. 3A, the adjusting device 300 includes an adjusting element 104′ and a sleeve 105'. The engaging portion 109 of the adjusting element 104′ is provided with a second direction limiting structure, which cooperates with the sleeve 105′ to limit an axial movement of the sleeve 105′ relative to the adjusting element 104′ in a second direction (axially upward). The second direction limiting structure includes a stop structure provided on the engaging portion 109 close to the first axial end 107 of the adjusting element 104′. The stop structure includes a recess 320 provided on the inner side wall 204 of the engaging portion 109. The sleeve 105′ is provided with a second protruding structure 302 close to its first end 112. The second protruding structure 302 includes an annular protrusion protruding radially outward from the side wall 203 of the sleeve 105'. The recess 320 cooperates with the annular protrusion to limit the axial movement of the sleeve 105′ relative to the adjusting element 104′ in the second direction (axially upward). The recess 320 is annular. In the above, the same terms and reference numerals as in FIGS. 2A-2C are used to represent the same structures as the adjusting device 103. For the purpose of clarity and conciseness, structures in FIG. 3B-3C that differ from those in FIGS. 2A-2C are labeled, such as, the second protruding structure 302 of the sleeve 105′ and the second direction limiting structure of the adjusting element 104'. Structures in FIGS. 3A-3C that are the same as those in FIGS. 2A-2C are not described again here.

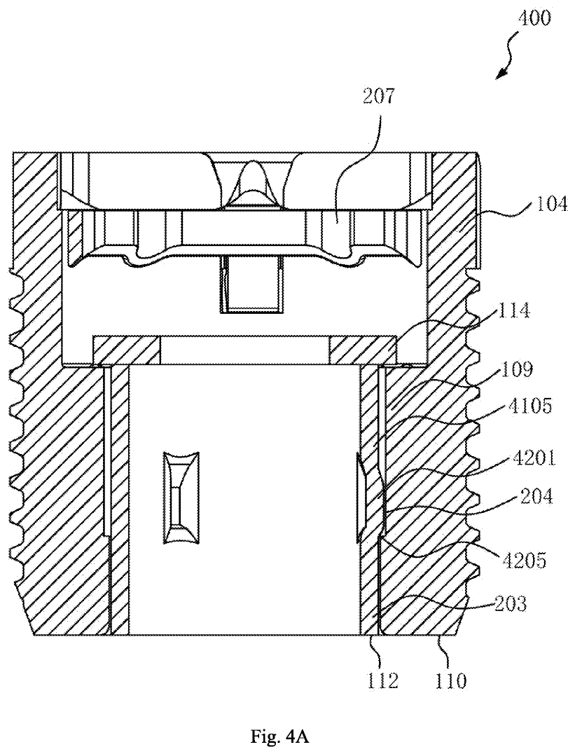

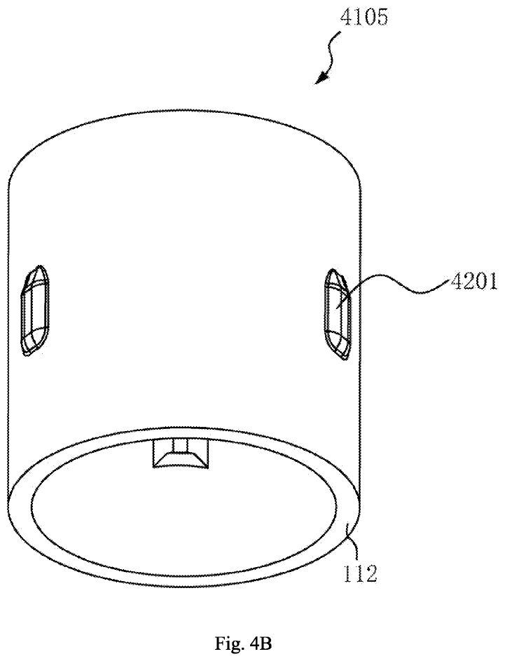

FIG. 4A is a cross-sectional view of an adjusting device 400 according to a third embodiment of the present disclosure, and FIG. 4B is a perspective view of a sleeve 4105 of the adjusting device 400 shown in FIG. 4A.

The adjusting device 400 in FIG. 4A has substantially the same structure as the adjusting device 103 in FIGS. 2A-2C. The sleeve 4105 included in the adjusting device 400 is slightly different from the sleeve 105 included in the adjusting device 103. As shown in FIGS. 4A-4B, the adjusting device 400 includes an adjusting element 104, a support plate 114 and a retaining element 207, which are the same as those in FIGS. 2A-2C. The support plate 114 is within the adjusting element 104. The support plate 114 is configured to receive a fastening device to enable the sleeve 4105 to be fastened to a second component. The retaining element 207 is detachably connected to the adjusting element 104. The adjusting element 104 is provided with a limiting portion 4205, which cooperates with the sleeve 4105 to limit the sleeve 4105 from moving out of the adjusting element 104 in a direction away from the retaining element 207. The retaining element 207 retains the support plate 114 between the sleeve 4105 and the retaining element 207, and limits the sleeve 4105 from moving out of the adjusting element 104 in a direction towards the retaining element 207 by the support plate 114. The retaining element 207 retains the support plate 114 between the sleeve 4105 and the retaining element 207 to further pre-assemble the support plate 114 in the adjusting device 400. The sleeve 4105 is in clearance fit with the engaging portion 109 in a radial direction.

The limiting portion 4205 includes a step portion provided on an inner side wall 204 of the engaging portion 109. The step portion has the same structure as that in FIGS. 2A-2C. The sleeve 4105 is provided with at least one projection 4201 protruding radially outward from its side wall 203. The step portion cooperates with the at least one projection 4201 to limit the sleeve 4105 from moving out of the adjusting element 104 in the direction away from the retaining element 207. The limiting portion 4205 is annular. The sleeve 4105 can be provided with a plurality of projections 4201 circumferentially spaced apart. At least one projection 4201 is in clearance fit with the inner side wall 204 of the engaging portion 109 above the limiting portion 4205, and the side wall 203 of the sleeve 4105 below the at least one projection 4201 is in clearance fit with the step portion. In the above, the same terms and reference numerals as in FIGS. 2A-2C are used to represent the same structures as the adjusting device 103.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. Furthermore, the technical effects and/or technical problems described in this description are exemplary rather than limiting; therefore, the disclosure in this description may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements, and/or substantial equivalents.

### DESCRIPTION OF MAIN REFERENCE NUMERALS:

A First Component 101
A Second Component 102
An Adjusting Device 103
An Adjusting Element 104/104′
A Sleeve 105/105'/4105
An Outer Thread 106
A First Axial End 107
A Second Axial End 108
An Engaging Portion 109
A First End Face 110
A Second End Face 111
A First End 112
A Second End 113
A Support Plate 114
A Central Opening 115/211
A Fastening Device 116
A Through Opening 117
An Opening 118/215
A Fastening Structure 119
A First Protruding Structure 201
A Second Protruding Structure 202/302
A Side Wall 203
An Inner Side Wall 204
A Step Portion 205
A Protruding Portion 206
A Retaining Element 207
An Installing Component 208
A Main Body 209
A Leg Portion 210
A Weakened Structure 212
A Snap-Fit Portion 213
A Recess 214/320
An Outer Drive Structure 216
An Inner Drive Structure 217
An Engaging End Portion 218
An Outside Portion 219
A Surface 220
An Adjusting Device 300/400
A Projection 4201
A Limiting Portion 4205

What is claimed is:

1. An adjusting device for connecting a first component to a second component in cooperation with a fastening device, comprising:
an adjusting element being axially through and comprising a first axial end and an engaging portion protruding radially inward, the engaging portion being annular and provided close to the first axial end, the adjusting element being configured to be threadedly connected to the first component; and
a sleeve being at least partly within the engaging portion of the adjusting element and configured to receive the fastening device to be fastened to the second component,
wherein the engaging portion of the adjusting element is provided with a first direction limiting structure and a second direction limiting structure, the first direction limiting structure cooperates with the sleeve to limit an axial movement of the sleeve relative to the adjusting element in a first direction, and the second direction limiting structure cooperates with the sleeve to limit an axial movement of the sleeve relative to the adjusting element in a second direction opposite to the first direction.

2. The adjusting device according to claim 1, wherein the engaging portion is in clearance fit with the sleeve in a radial direction.

3. The adjusting device according to claim 1, wherein the first direction limiting structure comprises a step portion provided on an inner side wall of the engaging portion;
wherein the second direction limiting structure comprises a stop structure provided on the engaging portion close to the first axial end of the adjusting element;
wherein the sleeve is provided with a first protruding structure protruding radially outward on a side wall thereof, and the sleeve is provided with a second protruding structure close to a first end thereof, the first end being close to the first axial end of the adjusting element;
wherein the step portion cooperates with the first protruding structure to limit the axial movement of the sleeve relative to the adjusting element in the first direction; and
wherein the stop structure cooperates with the second protruding structure to limit the axial movement of the sleeve relative to the adjusting element in the second direction.

4. The adjusting device according to claim 3, wherein the stop structure comprises a first end face of the engaging portion;
wherein the second protruding structure comprises a flange extending radially outward from the first end of the sleeve; and
wherein the first end face of the engaging portion abuts against the flange.

5. The adjusting device according to claim 3, wherein the stop structure comprises a recess provided on the inner side wall of the engaging portion;
wherein the second protruding structure comprises an annular protrusion protruding radially outward from the side wall of the sleeve; and
wherein the recess cooperates with the annular protrusion to limit the axial movement of the sleeve relative to the adjusting element in the second direction.

6. The adjusting device according to claim 3, wherein the step portion is annular; and
wherein the first protruding structure comprises a plurality of projections circumferentially spaced apart.

7. The adjusting device according to claim 3, wherein the inner side wall of the engaging portion above the step portion is in clearance fit with the first protruding structure; and
wherein a surface of the step portion facing the side wall of the sleeve is in clearance fit with the side wall of the sleeve below the first protruding structure.

8. The adjusting device according to claim 1, further comprising:
a support plate received within the adjusting element, the support plate being configured to receive the fastening device to enable the sleeve to be fastened to the second component; and
a retaining element detachably connected to the adjusting element to retain the support plate between the engaging portion and the retaining element.

9. The adjusting device according to claim 8, wherein the retaining element comprises an elastic annular member with a polygonal shape.

10. The adjusting device according to claim 8, wherein the engaging portion is provided with at least one protruding portion on a second end face thereof, the second end face being close to the support plate, the at least one protruding portion being contactable with the support plate.

11. The adjusting device according to claim 8, further comprising:
an outer drive structure provided on an outer side of the adjusting element and close to a second axial end of the adjusting element opposite to the first axial end; and/or
an inner drive structure provided on an inner side of the adjusting element and close to the second axial end of the adjusting element,
wherein the outer drive structure and/or the inner drive structure are configured to be driven to rotate so as to rotate the adjusting element.

12. An adjusting device for connecting a first component to a second component in cooperation with a fastening device, comprising:
an adjusting element being axially through and having an engaging portion protruding radially inward, the engaging portion being annular, the adjusting element being configured to be threadedly connected to the first component; and
a sleeve being at least partly within the engaging portion of the adjusting element and configured to receive the fastening device to be fastened to the second component,
a support plate being within the adjusting element and configured to receive the fastening device to enable the sleeve to be fastened to the second component; and
a retaining element being detachably connected to the adjusting element,
wherein the adjusting element is provided with a limiting portion, the limiting portion cooperates with the sleeve to limit the sleeve from moving out of the adjusting element in a direction away from the retaining element; and
wherein the retaining element retains the support plate between the sleeve and the retaining element, and limits the sleeve from moving out of the adjusting element in a direction towards the retaining element by the support plate.

13. The adjusting device according to claim 12, wherein the engaging portion is in clearance fit with the sleeve in a radial direction.

14. The adjusting device according to claim 12, wherein the limiting portion comprises a step portion provided on an inner side wall of the engaging portion;
wherein the sleeve is provided with at least one projection protruding radially outward from a side wall thereof; and
wherein the step portion cooperates with the at least one projection to limit the sleeve from moving out of the adjusting element in the direction away from the retaining element.

15. The adjusting device according to claim 14, wherein the step portion is annular; and
wherein the sleeve is provided with a plurality of projections circumferentially spaced apart.

16. The adjusting device according to claim 12, wherein the retaining element comprises an elastic annular member with a polygonal shape.

17. The adjusting device according to claim 12, wherein the engaging portion is provided with at least one protruding portion on an end face thereof, the end face being close to the support plate, the at least one protruding portion being contactable with the support plate.

18. The adjusting device according to claim 12, further comprising:
an outer drive structure provided on an outer side of the adjusting element and close to an axial end of the adjusting element away from the engaging portion; and/or
an inner drive structure provided on an inner side of the adjusting element and close to the axial end of the adjusting element,
wherein the outer drive structure and/or the inner drive structure are configured to be driven to rotate so as to rotate the adjusting element.
